(19) United States
(12) Patent Application Publication
(10) Pub. No.: US 2011/0114603 A1
(43) Pub. Date: May 19, 2011

(54) WIRE CUT ELECTRICAL DISCHARGE MACHINE

(75) Inventors: Chao-Chuang Mai, Taichung County (TW); Kung-Ying Li, Chiayi City (TW); Ming-Chi Chen, Yunlin County (TW)

(73) Assignee: INDUSTRIAL TECHNOLOGY RESEARCH INSTITUTE, Hsinchu (TW)

(21) Appl. No.: 12/764,020

(22) Filed: Apr. 20, 2010

(30) Foreign Application Priority Data
Nov. 18, 2009 (TW) TW098139093

(51) Int. Cl. B23H 1/00

(52) U.S. Cl. 219/69.12

(57) ABSTRACT

A wire cut electrical discharge machine is provided. The wire cut electrical discharge machine includes a base. At least two wire feeding and receiving components are disposed over the base. A working area is between the wire feeding and receiving components. At least two flaky wire electrodes are disposed in the working area, wherein ends of the flaky wire electrodes are respectively set on the wire feeding and receiving components.

### BACKGROUND OF THE INVENTION

1. Field of the Invention

The present invention relates to a wire cut electrical discharge machine, and in particular, to a wire electrode of a wire cut electrical discharge machine.

2. Description of the Related Art

The conventional wire cut electrical discharge machine has a movable wire electrode, which has a circular shaped cross section, forming an arc to a workpiece to perform an electrical discharge machining (EDM) process, thereby cutting the workpiece. The EDM process is advantageously used for hard die steel machining processes; especially for precision components and stamping die machining processes. The EDM process, however, has lower machining speed than other cutting tools. When a wire cut electrical discharge machine performs the EDM process with multi-electrodes, the machining speed thereof improves. In the conventional EDM process, however, wire electrodes often break. Specifically, wire electrodes wear and uneven flow of a working fluid between the wire electrodes and a workpiece, results in unstable electrical discharges, causing the wire electrodes to break. To solve this problem, the conventional wire cut electrical discharge machine has an automatic wire threading function to reduce machine idle time and human intervention. However, for a wire cut electrical discharge machine with multi-electrodes, when a wire electrode breaks, machine stoppage still occurs, thereby hindering machining speed thereof.

Thus, a novel wire cut electrical discharge machine and an electrical discharge machining method are desired.

### BRIEF SUMMARY OF INVENTION

A wire cut electrical discharge machine is provided. An exemplary embodiment of a wire cut electrical discharge machine comprises a base. At least two wire feeding and receiving components is disposed over the base. A working area is between the wire feeding and receiving components. At least two fabricated flaky wire electrodes are disposed in the working area, wherein ends of the flaky wire electrodes are respectively set on the wire feeding and receiving components.

Another exemplary embodiment of a wire cut electrical discharge machine comprises a base. At least two wire feeding and receiving components is disposed over the base. A working area is between the wire feeding and receiving components. At least two fabricated flaky wire electrodes are disposed in the working area, wherein ends of the flaky wire electrodes are respectively set on the wire feeding and receiving components. The flaky wire electrodes comprise at least two flaky wire electrode sets crossing each other, wherein each of the flaky wire electrode sets comprises at least two flaky wire electrodes.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic diagram showing one exemplary embodiment of a wire cut electrical discharge machine.

FIG. 2 is a schematic diagram showing another exemplary embodiment of a wire cut electrical discharge machine.

FIG. 3 is a three-dimensional diagram showing one exemplary embodiment of a flaky wire electrode.

FIGS. 4a to 4c show cross sections of various embodiments of flaky wire electrodes.

Table 1 is the process comparison between one exemplary embodiment of a wire cut electrical discharge machine and the conventional band saw, which are used in the metallurgical silicon ingot cutting process.

### DETAILED DESCRIPTION OF INVENTION

The following description is of a mode for carrying out the invention. This description is made for the purpose of illustrating the general principles of the invention and should not be taken in a limiting sense. The scope of the invention is best determined by reference to the appended claims. Wherever possible, the same reference numbers are used in the drawings and the descriptions to refer the same or like parts.

The present invention will be described with respect to particular embodiments and with reference to certain drawings, but the invention is not limited thereto and is only limited by the claims. The drawings described are only schematic and are non-limiting. In the drawings, the size of some of the elements may be exaggerated and not drawn to scale for illustrative purposes. The dimensions and the relative dimensions do not correspond to actual dimensions to practice of the invention.

One exemplary embodiment provides a multi-electrodes wire cut electrical discharge machine. A plurality of fabricated flaky wire electrodes serves as electrical discharge wire electrodes. Compared with the conventional wire cut electrical discharge machine with wire electrodes having circular cross sections, one exemplary embodiment of a wire cut electrical discharge machine according to the invention, can improve electrical discharge machining efficiency, avoid wire breakage, improve system utilization, improve machining precision, and improve repeatable usage of wire electrodes, thereby reducing material costs for wire cut electrical discharge machines.

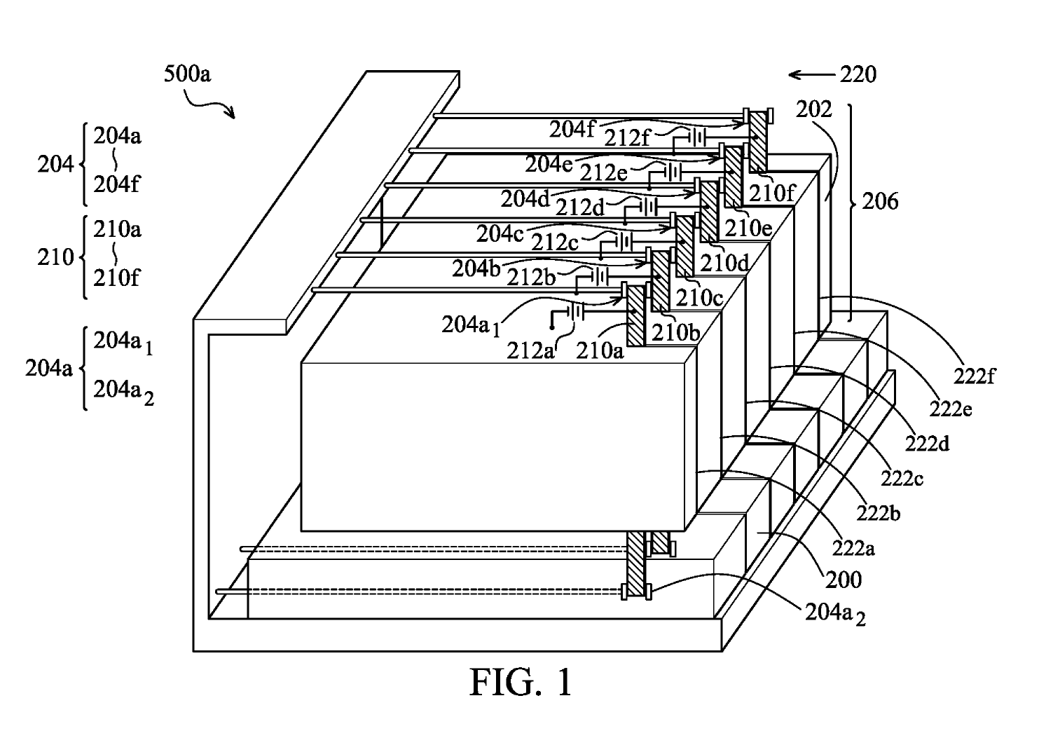

FIG. 1 is a schematic diagram showing one exemplary embodiment of a wire cut electrical discharge machine 500a. As shown in FIG. 1, one exemplary embodiment of a wire cut electrical discharge machine 500a comprises a base 200 for a workpiece 202 disposed thereon. A plurality of wire feeding and receiving components 204a˜204f is disposed over the base 200. A space among the wire feeding and receiving components 204a˜204f is defined as a working area 206. Additionally, each of the wire feeding and receiving components may have a head roller and a tail roller. For example, the wire feeding and receiving component 204a has a head roller 204aᵢ and a tail roller 204a₂. A plurality of fabricated flaky wire electrodes 210a˜210f parallel with each other is disposed in the working area 206. The flaky wire electrodes 210a˜210f are respectively set on the wire feeding and receiving components 204a˜204f. For example, two ends of the flaky wire electrode 210a are respectively set on the head roller 204aᵢ and the tail roller 204a₂ of the wire feeding and receiving component 204a. Therefore, the moving speed and the tension of each of the flaky wire electrodes may be controlled by the individual wire feeding and receiving component. The flaky wire electrodes 210a˜210f, which provide electrical discharge machining (EDM) pulses to perform the electrical discharge machining (EDM) process to cut the workpiece 202, may be respectively driven by individual power supplies 212a˜212f. When cutting the workpiece 202, a plurality of seams 222a˜222f are respectively formed in the workpiece 202, along a relative movement direction 220 between the flaky wire electrodes 210a˜210f and the base 200. Alternatively, the flaky wire electrodes 210a˜210f may also electrically connect to a same power supply (not shown). After cutting the workpiece 202, the workpiece 202 may be rotated with an angle and then disposed on the base 200 again to perform another EDM process, thereby forming seams along another direction.

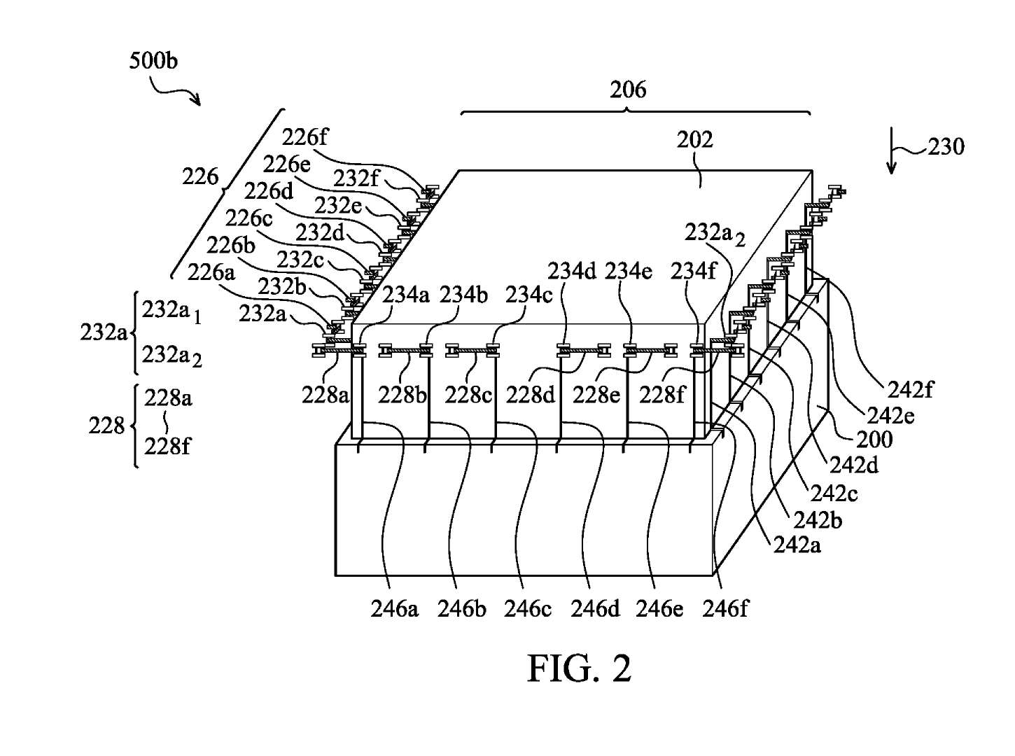

FIG. 2 is a schematic diagram showing another exemplary embodiment of a wire cut electrical discharge machine 500b. The wire cut electrical discharge machine 500b may comprise at least two flaky wire electrode sets 226 and 228 crossing each other, wherein the flaky wire electrode sets 226 and 228 respectively comprise a plurality of flaky wire electrodes 226a˜226f and 228a˜228f, which are parallel with each other. Similarly, two ends of each of the flaky wire electrodes 226a˜226f (or 228a˜228f) of the flaky wire electrode sets 226 (or 228) may be respectively set on a head roller and a tail roller of the wire feeding and receiving components 232a˜232f (or 234a˜234f). For example, two ends of the flaky wire electrode 226a are respectively set on a head roller 232a₁ and a tail roller 232a₂ of the wire feeding and receiving component 232a. Therefore, the moving speed and the tension of each of the flaky wire electrodes may be controlled by the individual wire feeding and receiving component. The flaky wire electrodes may be electrically connected to individual power supplies or to the same power supply (not shown), thereby providing electrical discharge machining (EDM) pulses to perform the electrical discharge machining (EDM) process to cut the workpiece 202. When cutting the workpiece 202, two sets of seams 242a˜242f and 246a˜246f crossing each other are respectively formed in the workpiece 202, along a relative movement direction 230 between the flaky wire electrodes 226a˜226f, 228a˜228f and the base 200.

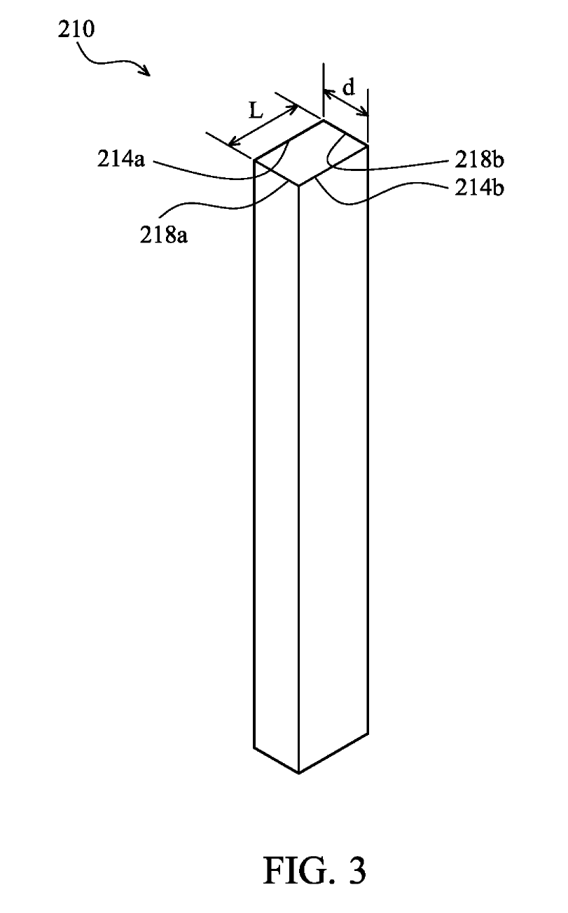

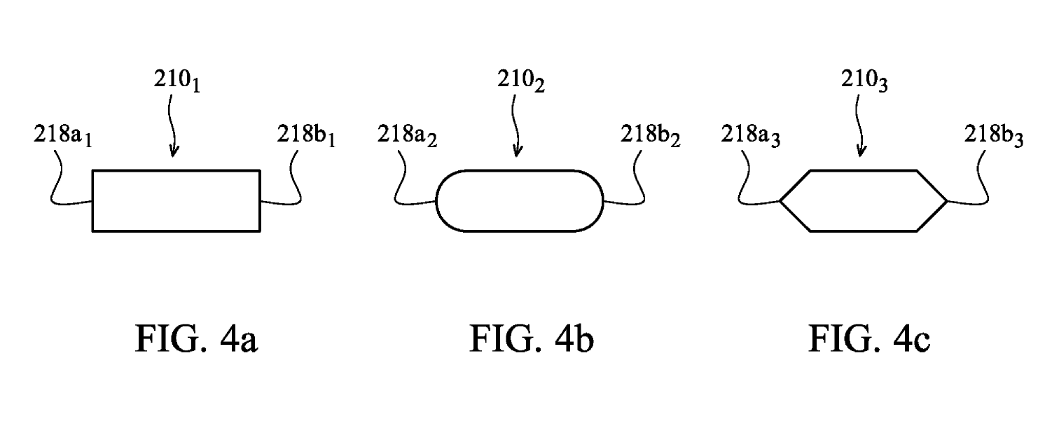

FIG. 3 is a three-dimensional diagram showing one exemplary embodiment of a flaky wire electrode 210. FIGS. 4a to 4c show cross sections of various embodiments of flaky wire electrodes 210₁, 210₂ and 210₃. In one embodiment, the flaky wire electrode 210 may comprise a longitudinal pillar, which has a pair of long parallel sides 214a and 214b and a pair of short parallel sides 218a and 218b. The long parallel sides 214a and 214b may have a width d between about 0.01 mm and about 0.4 mm. The long parallel sides 214a and 214b may have a length L, wherein a ratio of the length L to the width d may be larger than about 1 and smaller than about 20. It is noted that the parallel sides 214a and 214b are parallel to the relative movement direction 220 between the flaky wire electrodes 210a˜210f and the base 200 as shown in FIG. 1. Further, as shown on FIGS. 4a-4c, the flaky wire electrodes 210₁, 210₂ and 210₃ may comprise another pair of parallel sides respectively connected to the parallel sides 214a and 214b. The other pair of parallel sides may comprise straight sides 218a₁ and 218b₁, curved sides 218a₂ and 218b₂ or polygonal sides 218a₃ and 218b₃. The other pair of the parallel sides respectively connected to the parallel sides 214a and 214b may comprise other shapes, and are not limited herein. In one embodiment, the flaky wire electrode 210 may comprise copper, brass, molybdenum, tungsten, graphite, tungsten, steel, aluminum or zinc.

In one embodiment, the wire cut electrical discharge machines 500a and 500b may have a plurality of flaky wire electrodes 210, thereby performing highly efficient EDM processes with multi-electrodes. Additionally, the flaky wire electrode 210 is a longitudinal pillar with a fixed cross section width d, thereby creating a seam with a fixed width in the workpiece. The flaky wire electrode 210 may have a length L that is several times or even several dozen times larger than the width d. Therefore, when compared to the conventional circular shaped wire electrode, the tension of the flaky wire electrode 210 of the embodiment is improved, thereby reducing flexural and vibration problems of flaky wire electrodes. Thus, the flaky wire electrode 210 of the embodiment may assist in maintaining precision machining (that is, a precise width of the seam) without breaking, even if the flaky wire electrode 210 is worn during the EDM process. When performing the EDM process, only a front portion of the flaky wire electrode 210 is worn because of the larger length to width cross section ratio thereof, thereby avoiding breakage of the electrodes. Therefore, the flaky wire electrode 210 may be repeatedly used. Thus, reducing material costs while maintaining precision machinery. Meanwhile, the wire feeding and receiving component 204 (as shown in FIG. 1) used to roll the flaky wire electrode 210 may have forward and reverse rolling motion functions. The flaky wire electrode 210 may be rolled forward by the wire feeding and receiving component 204 till an end and then the flaky wire electrode 210 may be rolled reversely by the wire feeding and receiving component 204. Alternatively, the flaky wire electrode 210 may be reverse rolled by the wire feeding and receiving component 204 till an end and then the flaky wire electrode 210 may be rolled forward by the wire feeding and receiving component 204. Therefore, the flaky wire electrode 210 may be used to repeatedly cut the workpiece 202 during the EDM process. The wire cut electrical discharge machines 500a and 500b may be specially applied in a one-dimensional EDM process, such as cutting conductive hardened materials into pieces or thin slices, without rotating the flaky wire electrode. From the abrasion test result under a 5 A˜17 A applied current condition (the maximum applied current of the conventional circular wire electrode with a 0.3 mm diameter is only 4 A), one exemplary embodiment of the flaky wire electrode 210 of the invention can be continuously used for 4 hours without breakage. Also, the results show that the flaky wire electrode 210 has no obvious wear. Additionally, when cutting the workpiece having a width of 150 mm, a machining speed of the conventional circular wire electrode with a 0.3 mm diameter is about 0.4 mm/min, and the machining speed of the flaky wire electrode 210 of the invention with a width d of 0.3 mm can achieve about 1.0 mm/min.

Additionally, the wire cut electrical discharge machines 500a and 500b may be applied to perform the EDM process on solar energy materials such as metallurgical silicon ingots. By applying the flaky wire electrode, efficient machining can be improved over conventional circular shaped wire electrode, and the kerf loss (the amount of material loss during a cutting process) of cutting surfaces can be reduced. The conventional metallurgical silicon ingot is cut into pieces using a band saw tool, wherein the kerf loss of cutting surfaces is about 3 mm and above. Although the band saw machine has a band saw covered by a layer of diamond chips for hard and breakable materials cutting, a breakage problem still exists, especially when cutting materials containing SiC. Table 1 is the process comparison between one exemplary embodiment of a wire cut electrical discharge machine and the conventional band saw tool, which are used in the metallurgical silicon ingot cutting process.

| | one exemplary embodiment | |
|---|---|---|
| | of a wire cut electrical | the conventional |
| | discharge machine | band saw tool |
| consumptive material | flaky wire electrode | band saw |
| consumptive material | USD 900 (the flaky wire | USD 2000 |
| cost of cutting one | electrode is made of brass) | |
| silicon ingot | | |
| number of cuts (in one | 12 | 1 |
| time) | | |
| machining speed | 1.0 mm/min*12 | 5 mm/min*1 |
| material loss of cutting | 0.4 mm(kerf Loss) + | 3 mm (kerf Loss) + |
| surfaces | 1.4 mm (polishing loss) | 2 mm (polishing loss) |

From the Table 1, it is shown that the wire cut electrical discharge machines 500a and 500b used in the metallurgical silicon ingot cutting process, may reduce material loss of cutting surfaces when compared with the conventional band saw tool. Also, the wire cut electrical discharge machines 500a and 500b having the flaky wire electrode, may improve machining speed, reduce breakage and reduce material costs when compared with the conventional band saw tool. Therefore, the apparatus costs may be dramatically reduced when applying the flaky wire electrode.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wire cut electrical discharge machine, comprising:
a base;
at least two wire feeding and receiving components disposed over the base;
a working area between the wire feeding and receiving components; and
at least two fabricated flaky wire electrodes disposed in the working area, wherein ends of the flaky wire electrodes are respectively set on the wire feeding and receiving components.

2. The wire cut electrical discharge machine as claimed in claim 1, wherein a cross section of the wire electrode has a pair of parallel sides, wherein the pair of parallel sides have a width between about 0.01 mm and about 0.4 mm.

3. The wire cut electrical discharge machine as claimed in claim 1, wherein the pair of parallel sides have a length and a width, wherein a ratio of the length to the width is larger than about 1 and smaller than about 20.

4. The wire cut electrical discharge machine as claimed in claim 3, wherein the wire electrodes and the base have a direction of relative movement therebetween, wherein the direction of relative movement is parallel to the pair of parallel sides.

5. The wire cut electrical discharge machine as claimed in claim 3, wherein the cross section of the wire electrode has another pair of parallel sides respectively connecting to the pair of parallel sides.

6. The wire cut electrical discharge machine as claimed in claim 5, wherein the other pair of the parallel sides comprises straight sides, curved sides or polygonal sides.

7. The wire cut electrical discharge machine as claimed in claim 1, wherein the flaky wire electrodes comprise copper, brass, molybdenum, tungsten, graphite, tungsten, steel, aluminum or zinc.

8. The wire cut electrical discharge machine as claimed in claim 1, wherein the wire feeding and receiving components have forward and reverse rolling motion functions.

9. The wire cut electrical discharge machine as claimed in claim 4, wherein the direction of relative movement is a one-dimensional direction.

10. The wire cut electrical discharge machine as claimed in claim 1, further comprising at least one power supply system connecting to the flaky wire electrodes.

11. The wire cut electrical discharge machine as claimed in claim 1, wherein the flaky wire electrodes are parallel with each other.

12. The wire cut electrical discharge machine as claimed in claim 1, wherein the flaky wire electrodes comprise at least two flaky wire electrode sets crossing each other, wherein each of the flaky wire electrode sets comprises at least two flaky wire electrodes.
